(19) United States
(12) Patent Application Publication
(10) Pub. No.: US 2010/0058821 A1
(43) Pub. Date: Mar. 11, 2010

(54) PLANT AND PROCESS FOR TRANSFORMATION OF ORGANIC MATERIAL

(75) Inventors: Mauro Romano, Barbaiana Di Lainate-Lainate (IT); Michele Romano, Origgio (IT)

Correspondence Address: Pearne & Gordon LLP, 1801 East 9th Street, Suite 1200, Cleveland, OH, 44114-3108, US

(73) Assignee: TECNOIMPIANTI S.R.L., I-20025 LEGNANO (MILANO) (IT)

(21) Appl. No.: 12/595,350

(22) PCT Filed: Apr. 13, 2007
(86) PCT No.: PCT/IT2007/000274

§ 371 Date: Oct. 9, 2009

(51) Int. Cl. C05F 11/00; B01J 19/12

(52) U.S. Cl. 71/11; 422/186

(57) ABSTRACT

A transformation process of organic material (2), for the production of a fertiliser substrate, comprising the steps of grinding said organic material (2) and fermenting, in a reaction chamber, said ground organic material (6) and is characterised in that a microwave source (22) is involved in the removal of the bacterial load. The invention moreover comprises a plant for the actuation of the aforesaid process.

### FIELD OF APPLICATION

The present invention refers to a disposal process of organic material, in particular organic discards in general and animal excrements by means of transformation into a fertiliser substrate.

The present invention also refers to a transformation implant of organic material for the actuation of the corresponding process.

### PRIOR ART

As is well known, organic discards, in particular the organic portion of solid urban waste, generally comprise organic waste coming from supermarkets/malls, communities, canteens, restaurants, schools, homes (organic waste collection) and the like, cultivations, farms, slaughtering and agroindustrial transformation. At the current state of the art there are direct disposal methods or by means of the transformation of such waste actuated with different processes and implants. Incineration is the most used of the disposal methods; while fast, hygienic and not requiring waste differentiation, this definitely represents a very serious form of environmental pollution, in particular of the air, caused by the waste combustion emissions.

Among the transformation methods, biological composting has developed which involves the decomposition of waste by bacterial agents (aerobic or anaerobic). The products obtained are not directly polluting, but since the degree of decomposition of the substances involved is not controllable in a satisfactory manner, environmental pollution is caused due to the generation of bad odours, and the characteristics of the product resulting from the decomposition are not consistent.

Moreover, most of the biological decomposition methods require a long actuation period, usually 3-6 months if not more. Consequently, a decomposition method requires a very large availability of space for storing the waste to be decomposed, and possibly sites which are removed from inhabited areas due to the unpleasant generated odours.

Methods are known which employ additives known on the market with the name “KET”, of unknown composition, which permit the transformation of organic material into a fertiliser substrate in times of about 8-12 hours.

Overall, the slowness of the reaction and the non-availability of the transformation process of the organic material into fertiliser also makes this method unadvisable. The object of the present invention is to achieve a transformation process from organic material to fertiliser which lacks toxic components and has improved transformation times.

The associated object is to provide a plant for the transformation of organic material which carries out the above-mentioned process.

### SUMMARY OF THE INVENTION

The objects of the present invention are attained by means of a transformation process of organic material, for the production of a fertilising substrate, comprising the steps of

grinding said organic material

fermenting said ground organic material

characterised in that in said fermentation step said organic material is subjected to the action of a microwave source.

The invention also comprises an implant for the actuation of the described process, comprising:
a grinder for the size reduction of the organic material to be treated;
a reaction chamber which receives said ground organic material; characterised in that in said reaction chamber
a microwave source is provided.

The invention attains advantages of different nature:

the finished product of the transformation process is not a compost but a quality fertiliser substrate, such to both qualitatively improve both the soil and quantitatively improve the agricultural yield; it can therefore be used without contraindications in agriculture, for nurseries and for hobbies. It is also practically odourless, stable and with relative humidity that may be graded according to needs of use;

the transformation process does not cause any type of environmental pollution since it produces neither residual waste, nor waste water or gas/vapour emissions, except for water vapour emissions;

the implant/process permits the transformation of organic material into fertiliser substrate in a few hours (about 2-3 hours);

the transformation implant has low production, running and maintenance costs;

the transformation process does not generate waste and uncontrolled gaseous emissions.

The characteristics and advantages of the invention will be clear from the description, made below, of an embodiment thereof given as indicative and non-limiting with reference to the attached drawings.

### BRIEF DESCRIPTION OF THE DRAWINGS

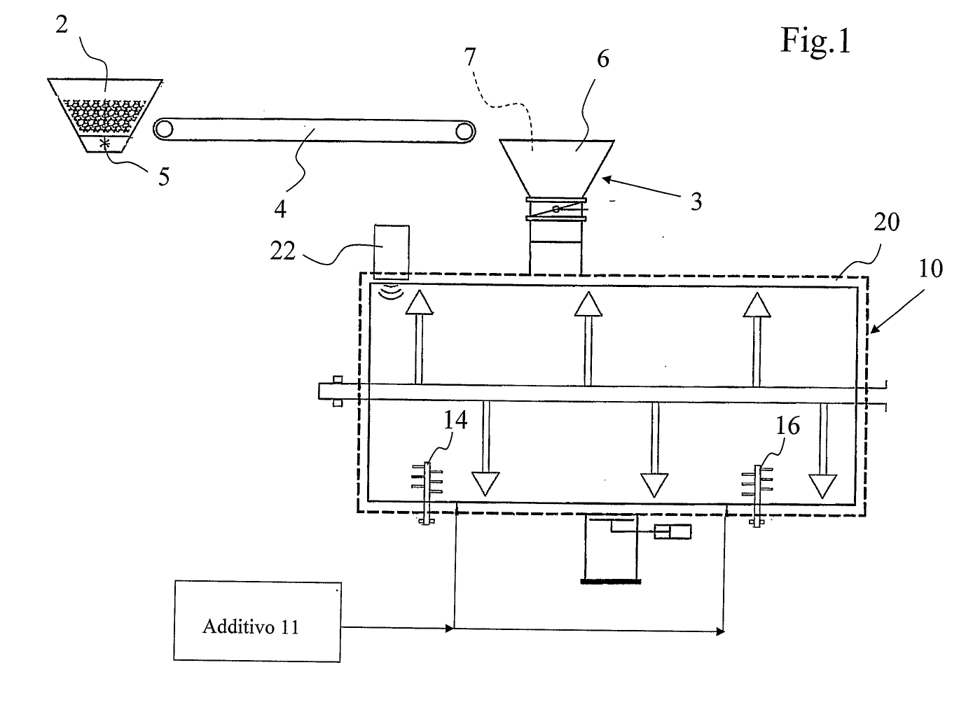

In FIG. 1, a tentative outline is shown of the transformation plant of organic material according to the invention.

### DETAILED DESCRIPTION

A transformation process of organic material into fertiliser substrate occurs in a continuous manner in a transformation implant 1, shown in FIG. 2.

The organic material 2 is collected by means of an appropriate separate collection system and transported to the aforesaid transformation plant. The organic material 2 is directed towards a load hopper 3 by means of conveyor means 4 such as, in particular, a conveyor belt.

Alternatively, the previously ground organic material can be poured directly in the load hopper 3.

The first treatment step essentially consists of the size reduction by means of grinding of the organic material 2, which occurs in a suitable grinder 5 prearranged upstream of the conveyor means 4.

The organic material 2 which has variable dimensions at the inlet is brought to a size comprised within specific predefined tolerance intervals. Acceptable size ranges for this process step go from about 7 mm² to 0.5 mm², preferably from 5 mm² to 1 mm², and in the preferred embodiment are about 2-3 mm².

In the preferred embodiment, the grinder 5 is of so-called knife type, i.e. comprising sharp tools mounted radially on two rotating horizontal shafts placed upstream of the conveyor means.

At the end of the grinding, the resulting organic material, referred to below as ground organic material 6, is ready for the subsequent fermentation step, which comprising the additional steps of

heating of the ground organic material 6,

mixing of the ground organic material 6 at a desired and predetermined temperature,

and occurs in an appropriate reaction chamber 10 with the addition of an additive 11 and optionally a structuring agent 7, whose object is to improve the granulometry of the ground organic material 6 and increases the ash content; in the preferred embodiment, one such structuring agent is a compound of silica, quartz and potassium feldspar (K[AlSi3O8] or orthoclase), metered in quantities which vary from 5%-20% by weight with respect to the organic material to be treated 2 and in particular usually metered at about 10%.

In the heating step of the ground organic material 6, this is heated and brought to a suitable temperature for the reaction with the additive; the heating occurs by means of a circulation system of diathermic oil, displaced outside the reaction chamber 10, which permits the circulation of the oil, in particular in the jacket 20 of the reaction chamber 10, and wherein the temperature of the diathermic oil is regulated with an electronic regulation system.

The additive 11 acts in an efficient manner when the fermentation step occurs at a temperature in the range of 35°-70° C., preferably between 50°-60° C. and in particular between 53°-57°, the optimal temperature being 55°.

The degree of acidity (pH) at which the fermentation step occurs is in the range of 4.3-5, preferably close to 4.8, and is appropriately corrected by adding lime (2.0 g/Kg of lime can raise the pH by one point), so that a pH is attained in the range of 5.3-6, preferably 5.8.

For the correction of the pH, both hydrated lime (Ca(OH)₂) and a special lime with high calcium hydroxide content can be used, the latter (AGRICALCIUM, produced by Calcidrata spa) employed in agriculture for reducing the acidity of soils and for ensuring the nutrition of the cultivations which also draw calcium from the soil.

The additive 11 is added when the ground organic material 6 and possibly the structuring agent 7 are completely within the reaction chamber 10 and it is metered with a controlled pressure injection system.

The additive 11 used is a solution of ferrous sulphate (FeSO4) and/or its precursors at 0.001% (by weight) with respect to the mass of organic material to be treated in a quantity of water equal, by weight, to 10% of the material itself. The ferrous sulphate is found on the market in the form of green-azure crystals and is rapidly oxidised to ferric sulphate (Fe(S0₄)₃).

The additive 11 can also be prepared as 1% FeS04 aqueous solution and added during the process in quantities equal to 0.1% by weight with respect to the organic material to be treated. The aqueous solution of ferrous sulphate is in reality an unstable suspension in which the ferrous sulphate tends to precipitate (and therefore requires being held under stirring) and is oxidised in the presence of oxygen to ferric sulphate.

After the addition of the additive 11 and the heating of the reaction chamber 10 up to a suitable temperature for the reaction and to a controlled pH, a suitable pump creates a pressure vacuum condition in the reaction chamber 10.

The stirring system is activated before the insertion of the ground organic material 6 and possible structuring agent, and the products inserted in the reaction chamber are then stirred and mixed with the additive 11. The mixing carried out is of variable speed type and is carried out by means of a mixer, in particular a ploughshare mixer of lined type (reaction chamber), and the mixing speed varies as a function of the product typology, fill level of the reaction chamber and relative humidity of the treated product. For continuous machine grinding, knives 14, 16 are used which permit the breaking of the organic material lumps formed during the reaction 6. Each knife has its own motor.

The microwave source 22 permits maintaining the temperature at the desired value during the mixing, in particular about 57°-58°, for a predetermined time in the range of one to two hours, in particular 1.5 hours.

Also in this step, the microwave source causes a drastic reduction of the bacterial load of the ground organic material 6.

The microwave source 22 acts either during the fermentation step or immediately after such step.

The fermentation step is carried out, overall, in about 2-3 hours, with evident advantages with respect to the prior art.

All the operations executed in the described steps of the process are controlled by means of a suitable program, by means of which it is possible to set and monitor all the operations and process parameters in real time, program which can be graphically displayed and stored in an archive file.

At the end of the mixing time, the product resulting from the fermentation step of the ground organic material 6 is ready for the subsequent drying step, which can occur in different settings, for example
controlled environment,
open air.

The product is unloaded from the reaction chamber 10 towards a traditional drying system, for example a drying tunnel, drying drum or the like. In this manner, the desired humidity degree is chosen for an improved drying, depending on the type of product to be dried.

Alternatively, the drying can also occur in open air, at environmental temperature and humidity conditions.

Overall, the transformation process of organic material according to the steps of grinding, fermenting and drying is of fast execution and provides a product which can be immediately used, without additional working.

The tests carried out ensure the optimal quality of the product, which has “fertiliser” characteristics pursuant to the Italian Law 19 Oct. 1984 and subsequent modifications and in respect of the legally binding legislative contents. The laboratory analysis data of the obtained fertiliser is reported in table 1.

TABLE 1
Analysis of the fertiliser substrate samples after the working process.

| | | | | | Amendment |
|---|---|---|---|---|---|
| | | | | | Green |
| | Measurement | | | | compost D.M. |
| Parameter | unit | Value | | Method | 27 Mar. 1998 |
| pH | | 5.88 | | — | 6.0-8.5 |
| Humidity | % | 8.29 | | UNI 10780 | <50% matter |
| | | | | | as is. |
| Degree of | % DH | 52.04* | | UNI 10780 | |
| humidification | | | | | |
| Rate of humidification | % HR | 12.85 | | UNI 10780 | >lO |
| C/N ratio (TOC/N-tot) | — | 15.74 | | — | <50 |
| | | matter | dry | | |
| | | as is | matter | | |
| Total organic carbon | % | 29.72 | 32.53 | UNI 10780 | >30% dry |
| | | | | | matter |
| Total nitrogen | % | 1.92 | 2.10 | UNI 10780 | >0.6% |
| Extractible organic | % TEC | 7.58 | 8.31 | UNI 10780 | |
| carbon | | | | | |
| Humified extractible | % HA + FA | 3.83 | 4.20 | UNI 10780 | >2.5% dry |
| organic carbon | | | | | matter |

Average values.

The fertiliser substrate, held at the air and analysed two months after its production, has an increased humification degree (average values>65% DH). Tests carried out in different analysis laboratories and field tests (directly in the greenhouse), using different samplings, qualify the substrate as a high quality fertiliser.

As can be noted from the entries in table 1, the obtained fertiliser exclusively contains substances with non-toxic characteristics.

The implant in its entirety is organised and managed so to ensure its correct functioning and a correct control of the reaction even when malfunctioning (even diffuse) conditions are verified.

The biochemical analyses have consistently shown an increase of the peroxidase activity of the samples (leaf tissue and tomato plant fruit) treated with the fertiliser substrate with respect to those untreated.

An interested data point regards the treated (leaf and fruit) samples infected with virus (plants infected with the virus TYLCSV—tomato yellow leaf curl Sardinia virus—carried by aleurodide Bemisia tabaci) which have a greater quantity of peroxidase (2-3 times greater) than those uninfected. The leaf tissues of the treated samples are morphologically healthier than the controls.

The results related to the antioxidant research, in general, favour a greater antioxidant presence in the treated samples infected by virus with respect to the reference samples.

1. Transformation process of organic material (2) for the production of a fertiliser substrate, comprising the steps of
grinding said organic material (2)
fermenting said ground organic material (6) in a reaction/mixing chamber (10), characterised in that in said fermentation step said organic material is subjected to the action of a microwave source (22).

2. Transformation process according to claim 1 wherein said organic material is subjected to the action of a microwave source (22) during said fermentation step.

3. Transformation process according to claim 1 wherein said organic material is subjected to the action of a microwave source (22) immediately after said fermentation step.

4. Transformation process according to claim 1 wherein said fermentation step comprises a step of heating the ground organic material (6).

5. Transformation process according to claim 1 wherein said fermentation step comprises a step of mixing said ground organic material (6) at a set and predefined temperature.

6. Transformation process according to claim 1 wherein said fermentation step is actuated with the addition of an additive (11).

7. Transformation process according to claim 6 wherein said additive (11) is a solution of ferrous sulphate (FeSO4) and/or its precursors.

8. Transformation process according to claim 7 wherein said additive (11) is a solution of ferrous sulphate (FeSO4).

9. Transformation process according to claim 7 wherein said additive (11) is a solution of ferrous sulphate (FeSO₄) at 0.001% with respect to the mass of said ground organic material (6) and water equal, by weight, to 10% with respect to the mass of said ground organic material (6).

10. Transformation process according to claim 7 wherein said additive (11) is a 1% ferrous sulphate (FeS04) aqueous solution added to said ground organic material (6) in a percentage equal to 0.1% by weight of the latter.

11. Transformation process according to claim 5 wherein said mixing step occurs at a temperature in the range of 35°-70°.

12. Transformation process according to claim 5 wherein said mixing step occurs at a temperature in the range of 50°-60°.

13. Transformation process according to claim 5 wherein said mixing step substantially occurs at the temperature of 55°.

14. Transformation process according to claim 11 wherein said heating step is achieved by means of a diathermic oil circulation system and said microwave source 22.

15. Transformation process according to claim 1 wherein said fermentation step is actuated with the possible addition of a structuring material (7).

16. Transformation process according to claim 15 wherein said structuring material is a silica, quartz and feldspar compound (K[AlSi₃O₈]).

17. Transformation process according to claim 1, further comprising a drying step of said ground organic material (6).

18. Transformation process according to claim 17 wherein said drying step occurs in a controlled environment.

19. Transformation implant (1) of organic material (2), for the production of a fertiliser substrate comprising
a grinder (5) for the size reduction of said organic material (2) to be treated;
a reaction chamber (10) which receives a ground organic material (6); characterised in that in said reaction chamber (10)
a microwave source (22) is provided.

20. Transformation implant (1) of organic material (2) according to claim 19 wherein in said reaction chamber (10) further mixing means (14, 16) are provided of said ground organic material (6).

21. Transformation implant (1) of organic material (2) according to claim 20 wherein said mixing means comprise knifes (14, 16) adapted to break the lumps of said organic material (6).

22. Transformation implant (1) of organic material (2) according to claim 19 wherein in said reaction chamber (10) drying means are furthermore provided for said ground organic material (6).

23. Transformation implant (1) of organic material (2) according to claim 19 comprising a controlled pressure injection system, outside said reaction chamber (10), adapted to permit the addition of an additive (11) to said ground organic material (6) in said reaction chamber (10).

24. Transformation implant (1) of organic material (2) according to claim 19 comprising a plant for vacuum production, outside said reaction chamber (10), adapted to place said reaction chamber (10) under controlled pressure.

25. Transformation implant (1) of organic material (2) for the actuation of the process described in claim 1.
